(19) United States
(12) Patent Application Publication
(10) Pub. No.: US 2021/0402842 A1
(43) Pub. Date: Dec. 30, 2021

(54) VEHICLE PROCESSING COMPONENT COOLING SYSTEMS AND METHODS

(71) Applicant: Woven Planet North America, Inc., Los Altos, CA (US)

(72) Inventors: Srinivasa Rao Damaraju, Fremont, CA (US); Saiman Shetty, Fremont, CA (US)

(73) Assignee: Woven Planet North America, Inc., Los Altos, CA (US)

(21) Appl. No.: 16/917,879

(22) Filed: Jun. 30, 2020

(51) Int. Cl. B60H 1/00; B60H 1/32

(52) U.S. Cl. CPC B60H 1/00271; B60H 1/00357; B60H 2001/00307; B60H 2001/003; B60H 1/323

(57) ABSTRACT

Systems and methods are provided for vehicle processing component cooling. A vehicle may include a compartment, a computing system including one or more processing components located within the compartment, and a cooling system configured to cool the one or more processing components. The cooling system may include a heat exchanger defining a plurality of flow channels. Each flow channel may be defined by an outlet and may be configured to provide cooling fluid. Operation of the processing components may heat the surrounding cabin air within the compartment through an air cooling operation. The cabin air from within the compartment may be directed through the heat exchanger to cool the cooling fluid. The compartment may be a trunk of the vehicle, and the heat exchanger may be located within the trunk and near the processing components.

### TECHNICAL FIELD

One or more embodiments of the present disclosure relate generally to vehicle systems and more particularly, for example, to systems and methods for cooling one or more processing components of a vehicle.

### BACKGROUND

Existing cooling systems configured to cool processing components of a vehicle typically rely on complex arrangements of heat exchangers and manifolds. For example, heat exchangers may be positioned in or near a front engine bay, while input and output manifolds may be positioned at other locations. This creates a large network of cooling channels distributed throughout the vehicle that add weight and may require a high capacity cooling pump. In addition, existing manifolds are typically fixed designs that do not permit adjustments to flow rates in response to changes in cooling requirements. When the space inside the vehicle is limited, the design and installation of an efficient cooling system within the vehicle can often be challenging. Therefore, there is a need in the art for systems and methods for a processing component cooling system that addresses the deficiencies noted above, other deficiencies known in the industry, or at least offers an alternative to current techniques.

### SUMMARY

Systems and methods are disclosed for a vehicle processing component cooling. In accordance with one or more embodiments, a vehicle having a compartment is provided. The vehicle may include a computing system including one or more processing components located within the compartment and a cooling system configured to cool the one or more processing components. The cooling system may include a heat exchanger defining a plurality of flow channels. Each flow channel of the plurality of flow channels may be defined by an outlet and configured to provide fluid. The cooling system may include one or more tubes positioned between the heat exchanger and the one or more processing components. The tubes may be configured to provide the fluid from the outlets of the heat exchanger to cool the one or more processing components.

In accordance with one or more embodiments, a cooling system configured to cool one or more processing components of a vehicle is provided. The cooling system may include a heat exchanger including a core, at least one inlet supported by the core and configured to receive cooling fluid, a plurality of outlets supported by the core and configured to receive the cooling fluid from the at least one inlet, and a plurality of flow channels defined by the at least one inlet and the plurality of outlets. The plurality of flow channels may extend through the core. The plurality of flow channels may be configured to direct the cooling fluid to the one or more processing components.

In accordance with one or more embodiments, a vehicle having a compartment exposed to cabin air within the vehicle is provided. The vehicle may include a computing system including one or more processing components located within the compartment, and a cooling system located within the compartment and configured to cool the one or more processing components. The cooling system may include a heat exchanger exposed to the cabin air within the vehicle so as to cool cooling fluid sent to the one or more processing components. The heat exchanger may include a core, at least one inlet supported by the core and configured to receive the cooling fluid, a plurality of outlets supported by the core and configured to receive the cooling fluid from the at least one inlet, and a plurality of flow channels defined by the at least one inlet and the plurality of outlets. The plurality of flow channels may extend through the core. The plurality of flow channels may be configured to direct the cooling fluid to the one or more processing components.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the disclosure described herein and should not be construed as a complete depiction of the scope of the disclosure.

FIG. 1 illustrates a block diagram of various components of a conventional vehicle.

FIG. 2 illustrates a block diagram of a vehicle in accordance with an embodiment of the disclosure.

FIG. 3 illustrates a heat exchanger having a plurality of outlets defining a plurality of flow channels in accordance with an embodiment of the disclosure.

FIG. 4 illustrates a diagram of a heat exchanger having a plurality of inlets and a plurality of outlets defining a plurality of flow channels in accordance with an embodiment of the disclosure.

FIG. 5 illustrates a diagram of a first heat exchanger having a non-uniformly distributed flow across a plurality of flow channels in accordance with an embodiment of the disclosure.

FIG. 6 illustrates a diagram of a second heat exchanger having a non-uniformly distributed flow across a plurality of flow channels in accordance with an embodiment of the disclosure.

FIG. 7 illustrates a system diagram of various components of a vehicle in accordance with an embodiment of the disclosure.

FIG. 8 illustrates a flow diagram of a process of cooling one or more components of a computing system in accordance with an embodiment of the disclosure.

FIG. 9 illustrates a diagram of a transportation management environment in accordance with an embodiment of the disclosure.

FIG. 10 illustrates a diagram of a computer system or computing device in accordance with an embodiment of the disclosure.

Embodiments of the disclosure and their advantages are best understood by referring to the detailed description that follows. It should be appreciated that like reference numerals are used to identify like elements illustrated in one or more of the figures.

### DETAILED DESCRIPTION

According to the present disclosure, systems and methods are provided for cooling one or more processing components of a vehicle. The vehicle may include a compartment (e.g., a trunk or rear portion of the vehicle cabin), a computing system including one or more processing components located within the compartment, and a cooling system configured to cool the liquid-cooled processing components. The cooling system may include a heat exchanger defining a plurality of flow channels and a fan configured to move air from the compartment across the heat exchanger to cool the processing components. The heat exchanger may include an inlet manifold structure with a plurality of inlets that collect coolant from the processing components into the heat exchanger. Additionally, or alternatively, the heat exchanger may include an outlet manifold structure with a plurality of outlets that disperse coolant from the heat exchanger to the processing components.

In the case of autonomous vehicles, the autonomy system equipment may occupy a lot of space and generate a large amount of heat, such as due to heavy processing tasks or due to the amount of processing components operating concurrently. Non-autonomous vehicles may also include processing components that require significant cooling for operation. In these and other examples, the potential exists for excessive heat to be generated and the excessive heat not to be properly dissipated. Excessive heat can lead to reduced operating tolerance, reduced efficiency, or failure of the processing components of the vehicle. The cooling system described herein may efficiently dissipate heat generated by one or more processing components of the vehicle, such as by reducing the size of the cooling system compared to conventional systems, reducing the number of potential failure points of the cooling system compared to conventional systems, optimizing the cooling system based on individual needs of the processing components, or any combination thereof.

The cooling system may be localized to the compartment of the vehicle. For example, rather than positioning various components of the cooling system along the length of the vehicle, such as positioning the heat exchanger at the front of the vehicle and various manifolds and pumps within the vehicle cabin, the cooling system components may be positioned within a single compartment of the vehicle (e.g., within the same compartment as the processing components), thereby decreasing the footprint of the cooling system compared to conventional systems. Such configurations may increase the efficiency of the cooling system. For example, instead of utilizing warm outside air to cool the heat exchanger, the present disclosure takes advantage of the proximity of the heat exchanger to cooler cabin air within the vehicle (relative to the outside air) to more efficiently cool the processing components. Such configurations may also reduce the number of cooling pipes (and the associated number of potential failure points) compared to conventional cooling systems. The reduction in piping may also increase control of the coolant flow rates to the various processing components of the computing system, such as because of shorter length of piping to manage.

Because the cooling system is localized to a single compartment of the vehicle, the cooling system can be positioned in and repositionable to many areas of the vehicle. For example, rather than receiving outside air, such as at the front of the vehicle, the heat exchanger can be easily positioned to one or more cabin areas of the vehicle (e.g., to the vehicle cabin, to the trunk of the vehicle, etc.) to efficiently cool the various processing components of the computing system via proximity of the heat exchanger to cabin air within the vehicle. The localized cooling system within the vehicle may take advantage of relatively constant, and often cooler, cabin air temperatures within the vehicle (relative to the outside air).

Operation of the processing components may heat the surrounding air within the compartment. For example, heat from the processing components may heat the surrounding air through convective heat transfer. The surrounding air heated by the processing components may be moved across the heat exchanger (e.g., by the fan) to cool the cooling fluid. As a result, the air used for air-cooling the processing components may be reused for a liquid cooling system. Often, the temperature of the air within the compartment, even the temperature of the heated air within the compartment, may be generally lower than the temperature of the outside environment. Thus, in many instances, moving the air from the compartment across the heat exchanger (even when heated through air cooling the processing components) may cool the cooling fluid of the cooling system more effectively and efficiently compared to moving outside air across the heat exchanger.

The cooling system can also utilize a combination of air-cooling and liquid-cooling to cool the processing components of the computing system. For example, the cabin air within the vehicle may be cooled via the vehicle's A/C unit, with the cooled air cooling the processing components through convective heat transfer. In addition, the cabin air within the vehicle can be re-used to cool the heat exchanger of the liquid cooling system. Thus, the cabin air within the vehicle may be used in combination with liquid coolant to cool the processing components, thereby increasing the efficiency of the cooling system.

Each flow channel of the heat exchanger may be associated with at least one (e.g., a subset of) processing component to cool the associated processing component(s). In some embodiments, one or more of the flow channels may be defined by one or more inlets and/or one or more outlets. The inlets and/or outlets may be replaced with different units having different dimensions, such that the flow characteristics (e.g., flow rate) of the associated flow channels may be altered to satisfy cooling requirements of the processing components.

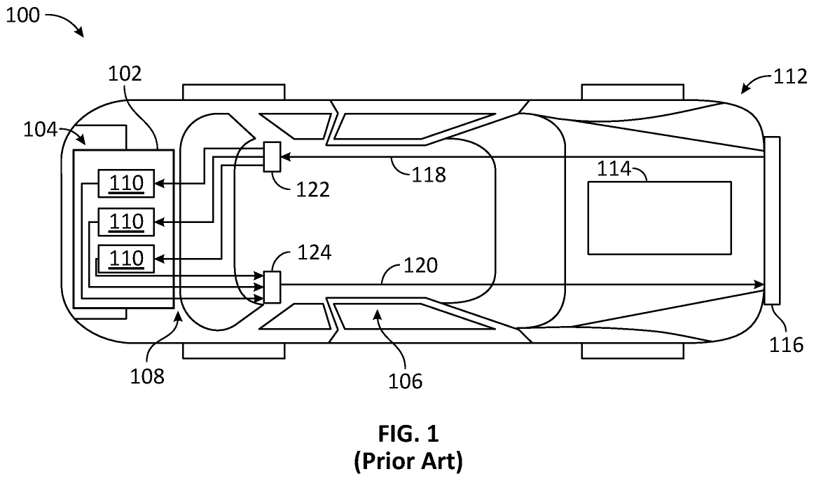

FIG. 1 illustrates a diagram of various components of a conventional vehicle 100. Referring to FIG. 1, the vehicle 100 (e.g., a car, truck, van, sport utility vehicle (SUV), etc.) includes a computing system 102 configured to monitor or control one or more operations of the vehicle 100. For example, the computing system 102 may include one or more processors, modules, or circuits configured to collect data, process data, transmit data, receive instructions, execute instructions, or the like during vehicle operation. For instance, the computing system 102 may be configured to collect, receive, or process data associated with vehicle movement, braking, stability, location, or status, among others. In some embodiments, the computing system 102 may be configured to collect, receive, or process measurement data of the surrounding environment.

In some embodiments, the computing system 102 may be configured to process data to control one or more operations of the vehicle 100. For example, depending on the application, the vehicle 100 may be autonomous or semi-autonomous, such that the vehicle 100 can sense the surrounding environment and navigate with little or no human input, as appropriate. In such embodiments, the computing system 102 may be configured to determine the surroundings of the vehicle 100 and make navigational control decisions such that the vehicle 100 may be safely navigated to a target destination or assist a human driver in doing the same. Although autonomous or semi-autonomous vehicles are described, the vehicle 100 may be manually drivable in some embodiments.

As shown, the vehicle 100 includes a compartment 104 in which the computing system 102 and/or other components are received. The compartment 104 may be a trunk of the vehicle 100 or a cargo area of the vehicle 100, such as an area of the vehicle 100 behind the last row of seats. In some embodiments, the compartment 104 may be separate from the vehicle cabin 106 (e.g., in the case of a trunk) or part of the vehicle cabin 106 (e.g., in the case of behind the last row of seats in a van or SUV). When the compartment 104 is embodied as a trunk, the vehicle 100 may include a partition 108 separating the compartment 104 from the vehicle cabin 106. Depending on the application, the compartment 104 may be fully enclosed or semi-closed.

As shown, the computing system 102 may include a plurality of processing components 110 located at the back of the vehicle 100, such as within the compartment 104. For example, the computing system 102 may include one or more electronic control units configured to control navigation of the vehicle 100. The number of system components and/or high processing demand of the computing system 102 may generate substantial heat during operation. For the computing system 102 to be operated within a safe operating temperature range, the vehicle 100 may include a cooling system. For example, the vehicle 100 may include a cooling system 112 configured to circulate liquid coolant or cooling fluid around or through heated parts of the computing system 102, such that the liquid coolant may absorb the heat generated by the computing system 102 to cool the computing system 102.

The cooling system 112 is integrated with an existing cooling system for cooling the vehicle's engine 114. For example, the vehicle 100 includes one or more radiators 116 located at the front of the vehicle 100 and outside of the vehicle cabin 106 (e.g., within the engine bay or compartment), such as part of a conventional automotive cooling system. To cool the computing system 102, liquid coolant is piped between the computing system 102 at the rear of the vehicle 100 and the one or more radiators 116 at the front of the vehicle 100. For instance, the cooling system 112 includes a supply line 118 providing liquid coolant from the radiator(s) 116 to the computing system 102 and a return line 120 providing liquid coolant from the computing system 102 to the radiator(s) 116.

With continued reference to FIG. 1, the cooling system 112 includes other features to facilitate piping of the liquid coolant between the computing system 102 and the radiator(s) 116. For instance, the cooling system 112 includes one or more external manifolds, such as an inlet manifold 122 and an outlet manifold 124. The inlet manifold 122 receives liquid coolant from the radiator(s) 116 via the supply line 118 and distributes the liquid coolant to the various processing components 110. The outlet manifold 124 collects the liquid coolant from the various processing components 110 into the return line 120 for piping back to the radiator(s) 116. Because the computing system 102 takes a substantial amount of space within the compartment 104, the inlet manifold 122 and/or the outlet manifold 124 are often located in a separate compartment of the vehicle 100, such as within the vehicle cabin 106, within the engine bay, or the like. Often, this requires a substantial amount of piping between the various components of the cooling system 112 as the separate components are located anywhere along the length of the vehicle 100. The amount and/or length of the piping may increase pressure drops along the length of the piping, requiring more powerful pumps to circulate the liquid coolant. The amount and/or length of the piping may also increase the number of potential failure points within the cooling system 112.

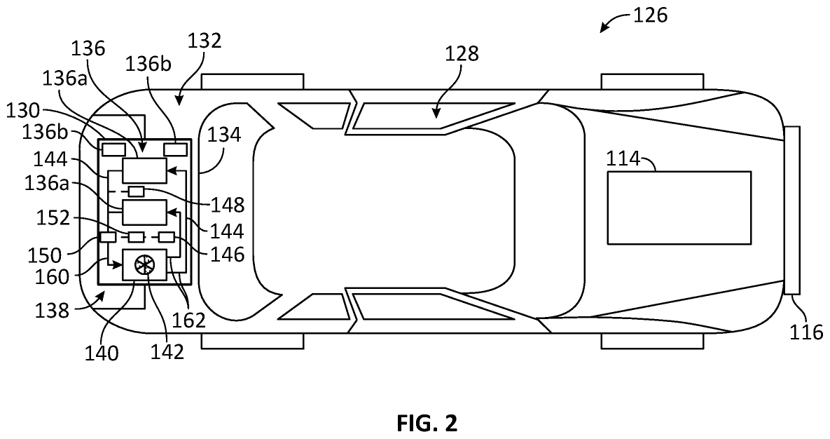

FIG. 2 illustrates a diagram of a vehicle 126 in accordance with an embodiment of the disclosure. Except as otherwise noted below, the vehicle 126 may be similar to vehicle 100 described above. For example, vehicle 126 may include a vehicle cabin 128 and a compartment 130 in which a computing system 132 is received. The compartment 130 may be separate from the vehicle cabin 128 (e.g., a trunk of the vehicle 126) or part of the vehicle cabin 128 (e.g., behind the last row of seats in a van or SUV). In such embodiments, the vehicle 126 may include a partition or division 134, such as a static structural partition between the vehicle cabin 128 and the compartment 130, such as in a sedan, or a non-structural division, such as in a minivan, van, or SUV. In some embodiments, the compartment 130 may be exposed to the vehicle cabin 128, such that the compartment 130 can receive cabin air from within the vehicle cabin 128. In some embodiments, the compartment 130 may be exposed to cabin air within the vehicle 126. As described more fully below, the compartment 130 can direct cabin air therethrough to cool at least a portion of the computing system 132. As described herein, “cabin air” refers to the air within the vehicle 126, such as the air within the vehicle cabin 128 and/or compartment 130, whereas “outside air” refers to the air surrounding the vehicle 126. As a result, “cabin air” is not strictly limited to the air within the vehicle cabin 128 and may include the air within the trunk or other compartment of the vehicle 126 that is separate from the vehicle cabin 128.

Like computing system 102, the computing system 132 may include a plurality of processing components 136 located at the back of the vehicle 100, such as within the compartment 130, to control navigation of the vehicle 126. Like computing system 102, computing system 132 may generate substantial heat during operation. For the computing system 132 to be operated within a safe operating temperature range, the vehicle 126 may include a cooling system 138 configured to cool the computing system 132 located within a compartment 130 (e.g., trunk, rear of vehicle cabin 128, etc.) of the vehicle 126. For example, the cooling system 138 may circulate liquid coolant or cooling fluid around or through heated parts of the computing system 132, such that the liquid coolant may absorb the heat generated by the computing system 132 to cool the computing system 132.

As shown in FIG. 2, the cooling system 138 may include at least one of a heat exchanger 140 and a fan 142 configured to cool the processing components 136. For example, liquid coolant may be circulated around or through the processing components 136, such that the liquid coolant absorbs the heat generated by the processing components 136. The heated coolant is then circulated through the heat exchanger 140, such as via cooling pipes or lines 144 running between the processing components 136 and the heat exchanger 140. The heat exchanger 140 may be configured to cool the liquid coolant sent to the processing components 136. For example, as the heated coolant is circulated through the heat exchanger 140, the fan 142 may move (e.g., pull) air across the heat exchanger 140 to cool the liquid coolant by transferring heat from the liquid coolant to the air. After the liquid coolant is cooled, the cooled liquid coolant is circulated back to the processing components 136 for cooling.

As shown, the heat exchanger 140 may be located within the compartment 130, such that the heat exchanger 140 is exposed to the cabin air within the vehicle 100. In this manner, the cooling system 138 may be relocated to or repositioned within the compartment 130. As a result, the computing system 132 and associated cooling system 138 may be localized to the compartment 130 of the vehicle 126, unlike vehicle 100. In such embodiments, the fan 142 may be configured to move air from the compartment 130 across the heat exchanger 140 to cool the computing system 132. Such configurations may allow the cooling system 138 to be more easily installed in a vehicle retrofitted for autonomous or semi-autonomous operation compared to integrating the cooling system 138 with existing cooling systems of the vehicle, such as a cooling system located in the engine compartment to primarily cool the engine 122 of the vehicle 126. For example, the localized cooling system 138 may reduce the number/length of cooling pipes 144 and eliminate tie-in points, thereby decreasing costs and increasing the reliability of the system (by reducing the number of potential failure points). In addition, the localized cooling system 138 may reduce the need to create penetrations through the vehicle cabin 128 (e.g., through the partition 134) or through the compartment 130.

Positioning the heat exchanger 140 within the same compartment of the vehicle 126 in which the processing components 136 are located (e.g., compartment 130) may enable the cooling system 138 to be relocated to almost anywhere along the vehicle 126. For example, by decoupling the cooling system 138 from the existing engine cooling system of the vehicle 126, the cooling system 138 may be positioned anywhere within the vehicle 126 because air is not required to be fed through the front intake of the vehicle 126 to the heat exchanger 140. The decoupling of the cooling system 138 from the existing engine cooling system of the vehicle 126 may also allow the heat exchanger 140 to be positioned closer to the processing components 136 and take advantage of cabin air cooling within the vehicle 126.

With continued reference to FIG. 2, the processing components 136 may include one or more liquid-cooled processing components 136a and one or more air-cooled processing components 136b. The processing components 136a may be cooled primarily or generally using a liquid cooling process, such as via liquid coolant absorbing the heat generated by the processing components 136a. The processing components 136b may be cooled primarily or generally using an air cooling process, such as via heat generated by the processing components 136b being dissipated to the surrounding air through convective heat transfer. In some embodiments, processing components 136a may be cooled using both a liquid cooling process and an air cooling process. Similarly, processing components 136b may be cooled using both an air cooling process and a liquid cooling process. As a result, one or more features of processing components 136a may be applied to processing components 136b, and vice versa. In this manner, each processing component 136 (e.g., processing component 136a or processing component 136b) may be liquid cooled and/or air cooled. For example, processing components 136a or processing components 136b may be cooled by a combination of the cabin air within the vehicle 100 and liquid coolant, as detailed below.

Like the processing components 136a, the processing components 136b may be located within the compartment 130 and may include one or more air-cooled electronic control units configured to control navigation of the vehicle 126. Like the liquid-cooled processing components 136, the processing components 136b may generate heat during operation. In such embodiments, the generated heat may be dissipated from the processing components 136b to the air surrounding the components (e.g., through convective heat transfer between the hotter processing components 136b and the cooler surrounding air). In some embodiments, the processing components 136b may include one or more features increasing convective heat transfer between the processing components 136b and the surrounding air. For instance, the processing components 136b may include one or more heat sinks configured to increase the surface area in contact with the surrounding air.

When the processing components 136 are located within the compartment 130, the heat may be dissipated from the processing components 136 (e.g., from the processing components 136b and/or the processing components 136a) to the surrounding air within the compartment 130 itself. In such embodiments, the fan 142 may be configured to move the heated surrounding air (heated through air-cooling the processing components 136b and/or the processing components 136a) across the heat exchanger 136 to cool the processing components 136. In this manner, heated exhaust air from the air cooling operations may be reused and applied to cool the processing components 136 through the heat exchanger 136. As a result, the air used for air-cooling the processing components 136 may be reused for the cooling system 138.

In some embodiments, reusing the heated exhaust air from the air cooling operations may increase efficiency of the cooling system 138. For instance, even when heated by the processing components 136b (and processing components 136a), the temperature of the air within the compartment 130 is generally lower than the temperature of the liquid coolant within the cooling system 138. In addition, the temperature of the air within the compartment 130 may be generally lower than the temperature of the outside environment. Thus, in many instances, moving the air from the compartment 130 (even when heated through air cooling operations) across the heat exchanger 140 may cool the liquid coolant of the cooling system 138 more effectively (and efficiently) compared to moving outside air across the heat exchanger 140.

In some embodiments, operation of the cooling system 138 may increase efficiency or capacity of the air cooling operations. For example, operation of the fan 142 to move air across the heat exchanger 140 may increase air flow within the compartment 130 to increase airflow across the processing components 136. As a result, operation of one cooling system type may increase efficiency of the other cooling system type.

With continued reference to FIG. 2, the cooling system 138 may include other features. For example, the cooling system 138 may include one or more temperature sensors 146, one or more flow sensors 148, a pump 150, and a controller 152. The temperature sensors 146 may be configured to determine the temperature of the liquid coolant, the compartment 130, the processing components 136, or the like. The flow sensors 148 may be configured to determine the flow rate of liquid coolant within the cooling pipes 144, such as the flow rate supplied to each processing component 136. In some embodiments, a flow sensor 148 may be positioned at each outlet 162 to monitor the flow rate provided to each processing component 136 or group of processing components 136. The pump 150 may be any pump structure configured to provide motive force moving the liquid coolant through the heat exchanger 140 and the cooling pipes 144. The controller 152 may be any type of processor configured to control operation of the pump 150 and/or the fan 142, such as to adjust the flow rate of coolant through the heat exchanger and/or the cooling pipes 144, adjust the speed of the fan 142, or the like, based on data received from the temperature sensors 146 and/or the flow sensors 148.

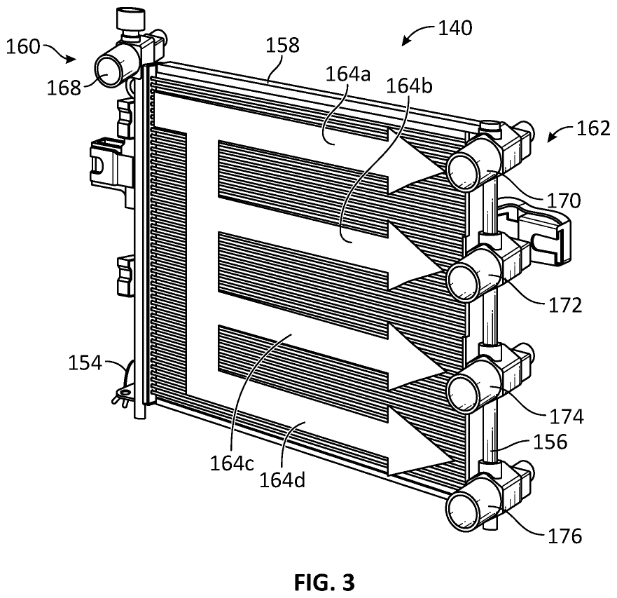

FIGS. 3-6 illustrate various diagrams of the heat exchanger 140 in accordance with an embodiment of the disclosure. As described herein, the heat exchanger 140 may function as a manifold for the cooling system 138. For example, the heat exchanger 140 may include an inlet manifold structure 154 configured to collect liquid coolant from the processing components 136a. In some embodiment, the heat exchanger 140 may include an outlet manifold structure 156 configured to disperse liquid coolant from the heat exchanger 140. As a result, the heat exchanger 140 may function to both transfer heat from the liquid coolant to the surrounding air and collect and/or distribute the liquid coolant using a manifold structure.

Referring to FIG. 3, the heat exchanger 140 may include a core 158, one or more inlets 160, and one or more outlets 162. In such embodiments, liquid coolant may flow through the core 158 of the heat exchanger 140 from the one or more inlets 160 to the one or more outlets 162. Any desired number of inlets 160 and outlets 162 may be provided in the various embodiments discussed herein. The inlets 160 and outlets 162 may define, at least partially, a plurality of flow channels. For example, the inlets 160 and outlets 162 may define a first flow channel 164a and a second flow channel 164b. In some embodiments, the inlets 160 and outlets 162 may define additional flow channels, such as a third flow channel 164c and a fourth flow channel 164d, and so on. Such examples are illustrative only, and the inlets 160 and outlets 162 may define any number of flow channels through the heat exchanger 140.

Each flow channel may be defined at least by an inlet 160 of the heat exchanger 140 and an outlet 162 of the heat exchanger 140. For example, as shown in FIG. 3, the first flow channel 164a may be defined by a first inlet 168 and a first outlet 170. The additional flow channels, such as the second flow channel 164b, third flow channel 164c, and fourth flow channel 164d, may be defined by different outlets 162 and/or different inlets 160 of the heat exchanger 140. For instance, the second flow channel 164b may be defined by the first inlet 168 and a second outlet 172. Similarly, the third flow channel 164c may be defined by the first inlet 168 and a third outlet 174, and the fourth flow channel 164d may be defined by the first inlet 168 and a fourth outlet 176. In such embodiments, liquid coolant may enter the first inlet 168 and be dispersed to the first outlet 170, second outlet 172, third outlet 174, and fourth outlet 176 for circulation to the processing components 136a.

As described herein, each flow channel may be configured to cool at least one processing component. For instance, each flow channel of the heat exchanger 140 may be associated with a subset of processing components 136a. Specifically, the first flow channel 164a may be associated with a first subset of processing components, the second flow channel 164b may be associated with a second subset of processing components, the third flow channel 164c may be associated with a third subset of processing components, and the fourth flow channel 164d may be associated with a fourth subset of processing components.

Each of the first, second, third, and fourth subsets may include one or more processing components 136a (e.g., a single processing component 136a, multiple processing components 136a, a bank of processing components 136a, a group of processing components 136a, an assembly of processing components 136a, etc.). In such embodiments, cooled liquid coolant of the first flow channel 164a and exiting the first outlet 170 of the heat exchanger 140 may be circulated to the first subset of processing components. In like manner, cooled liquid coolant of the second flow channel 164b and exiting the second outlet 172 of the heat exchanger 140 may be circulated to the second subset of processing components, cooled liquid coolant of the third flow channel 164c and exiting the third outlet 174 of the heat exchanger 140 may be circulated to the third subset of processing components, and cooled liquid coolant of the fourth flow channel 164d and exiting the fourth outlet 176 of the heat exchanger 140 may be circulated to the fourth subset of processing components.

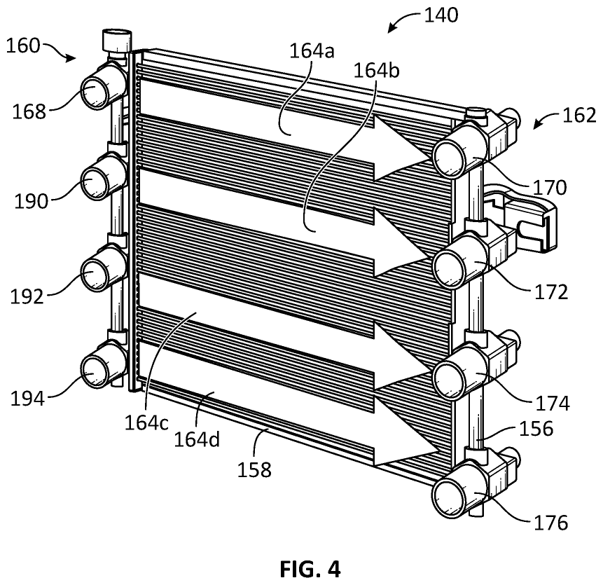

Referring to FIG. 4, the first, second, third, and fourth flow channels 164a, 164b, 164c, 164d may be defined by separate inlets 160 and outlets 162 of the heat exchanger 140. For example, the first flow channel 164a may be defined by the first inlet 168 and the first outlet 170, the second flow channel 164b may be defined by a second inlet 190 and the second outlet 172, the third flow channel 164c may be defined by a third inlet 192 and the third outlet 174, and the fourth flow channel 164d may be defined by a fourth inlet 194 and the fourth outlet 176. In such embodiments, liquid coolant from the first subset of processing components may enter the first inlet 168, move through the core 158 of the heat exchanger 140, and be dispersed from the first outlet 170 for circulation back to the first subset of processing components. Similarly, liquid coolant from the second subset of processing components may enter the second inlet 190, move through the core 158 of the heat exchanger 140, and be dispersed from the second outlet 172 for circulation back to the second subset of processing components. In like manner, liquid coolant from the third subset of processing components may enter the third inlet 192, move through the core 158 of the heat exchanger 140, and be dispersed from the third outlet 174 for circulation back to the third subset of processing components, and liquid coolant from the fourth subset of processing components may enter the fourth inlet 194, move through the core 158 of the heat exchanger 140, and be dispersed from the fourth outlet 176 for circulation back to the fourth subset of processing components.

Referring to FIGS. 2 and 3, the heat exchanger 140 may be configured to produce a uniformly or generally uniformly distributed flow across the plurality of flow channels. For example, the first, second, third, and fourth flow channels 164a, 164b, 164c, 164d may be configured similarly such that one or more flow characteristics of the respective flow channels are similar or identical (e.g., flow rate, flow volume, pressure differential, etc.). As one example, the first inlet 168, second inlet 190, third inlet 192, and fourth inlet 194 may have similar or identical internal diameters. Similarly, the first outlet 170, second outlet 172, third outlet 174, and fourth outlet 176 may have similar or identical internal diameters. The internal dimensions of the first flow channel 164a, second flow channel 164b, third flow channel 164c, and fourth flow channel 164d within the heat exchanger 140 may also be similar or identical. In such embodiments, flow to the first, second, third, and fourth subsets of liquid-cooled processing components may be similar or identical.

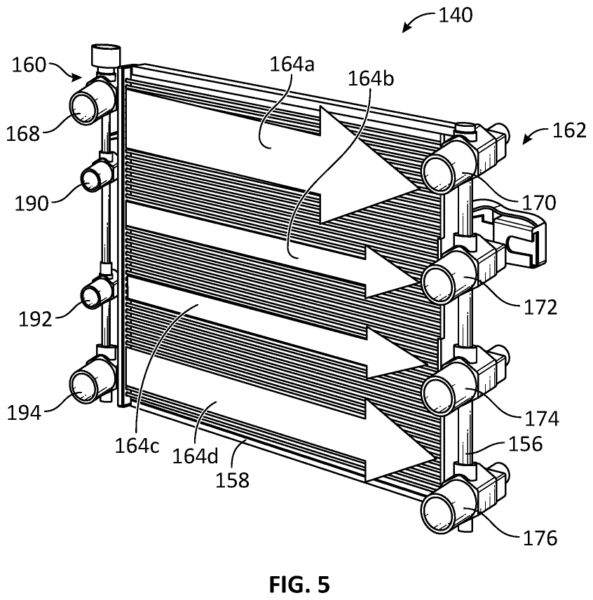

Referring to FIGS. 4 and 5, the heat exchanger 140 may be configured to produce a nonuniformly distributed flow across the plurality of flow channels. For instance, one or more characteristics of the flow channels may be varied to alter the flow characteristics between the various flow channels. As one example, the flow characteristics of the flow channels may be varied by changing the dimensions of the inlet 160 and/or outlet 162. Specifically, the internal diameter of an inlet 160 and/or outlet 162 may be changed to alter the flow characteristics (e.g., flow rate) of the respective flow channel. As shown in FIG. 5, at least one of the first inlet 168, second inlet 190, third inlet 192, and fourth inlet 194 may have a different internal diameter, such as the second inlet 190 and third inlet 192 having a smaller internal diameter compared to the first inlet 168 and fourth inlet 194.

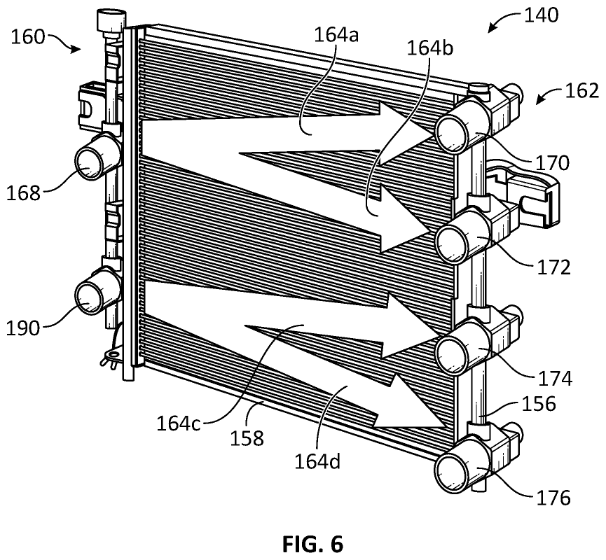

As shown in FIG. 6, the nonuniform flow distribution may result from at least one of a different number of inlets 160 or a different number of outlets 162. For instance, the heat exchanger 140 may include a greater number of outlets 162, such as two inlets 160 (e.g., the first inlet 168 and the second inlet 190) and more than two outlets 162 (e.g., the first, second, third, and fourth outlets 170, 172, 174, 176), as shown. In such embodiments, the third flow channel 164c may be defined by the second inlet 190 and the third outlet 174, and the fourth flow channel 164d may be defined by the second inlet 190 and the fourth outlet 176. As a result, two or more flow channels may share an inlet 160. In some embodiments, the heat exchanger 140 may include a greater number of inlets 160. In such embodiments, two or more flow channels may share an outlet 162.

The flow characteristics between the flow channels may be altered in other ways. For example, at least one of the first outlet 170, second outlet 172, third outlet 174, and fourth outlet 176 may have a different internal diameter. As a result, the outlets 162 may have different internal diameters so that the various outlets 162 have different fluid flow rates. For example, at least two of the outlets 162 may have different internal diameters so that a first outlet of the at least two outlets is characterized as having a first flow rate and a second outlet of the at least two outlets is characterized as having a second flow rate different (e.g., less) than the first fluid flow rate. Such configurations may allow the cooling system 112 to be tailored to the individual cooling requirements of the processing components 136. For example, the processing components 136 may include a first processing component having a first operating temperature and a second processing component having a second operating temperature different than the first operating temperature. In such embodiments, the first processing component and the second processing component may be cooled by different flow channels, the different flow channels operating at different flow rates of liquid coolant.

In some embodiments, the internal dimensions of the first flow channel 164a, second flow channel 164b, third flow channel 164c, and fourth flow channel 164d within the heat exchanger 140 itself may be different across the flow channels. In some embodiments, at least one of the inlet 160 or the outlet 162 of each flow channel may be interchangeable with a different inlet 160 or outlet 162 to vary a flow characteristic of the respective flow channel. As a result, the inlets 160 and/or outlets 162 of the heat exchanger 140 may be modular, such that existing inlets 160 and/or outlets 162 may be interchanged with other inlets 160 and/or outlets 162 of different dimensions or other characteristics.

In these and other embodiments, the flow characteristics (e.g., flow rate) of each flow channel of the heat exchanger 140 may be optimized or tailored to cool the processing components 136a associated with the respective flow channel. For instance, by altering the characteristics of the inlets 160, outlets 162, and/or flow channels, the heat exchanger 140 may be configured to produce a target flow rate specific for each processing component or subset of processing components of the computing system 132. As one non-limiting example, the different processing components or subsets of processing components may require different cooling requirements, and altering the flow characteristics of the different flow channels to meet those requirements may allow the heat exchanger 140 to service many different processing components without additional components, such as a separate manifold. In addition, the modularity of the heat exchanger 140 may allow the heat exchanger 140 to be installed on many different vehicles with different computing systems (e.g., a fully-autonomous vehicle vs. a semi-autonomous vehicle, a fully/semi-autonomous vehicle vs. a manually drivable vehicle, etc.).

The modularity of the heat exchanger 140 may also allow the heat exchanger 140 to be modified with modification to the computing system 132, such as additional processing components added to the computing system 132, one or more processing components removed from the computing system 132, one or more processing components of the computing system 132 replaced, and the like. For example, one or more processing components of the computing system 132 may be changed out with one or more components having different cooling requirements. In such embodiments, the inlets 160 and/or outlets 162 of the heat exchanger 140 may be changed to adjust the flow rates as appropriate.

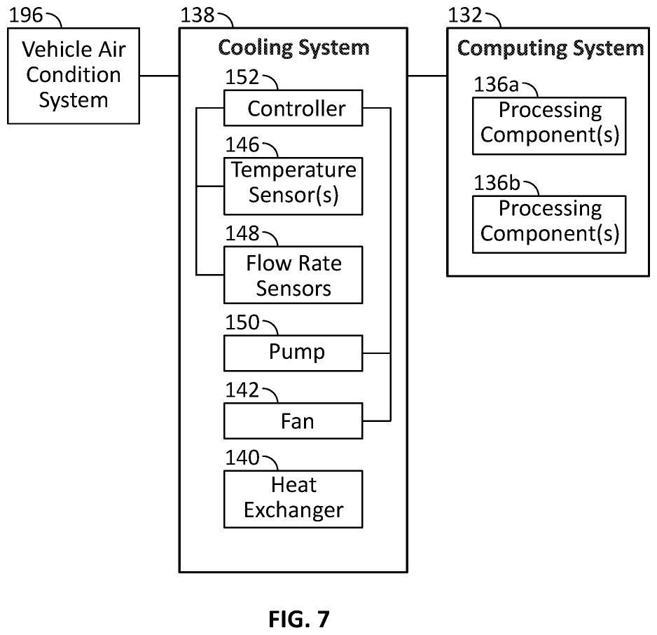

FIG. 7 illustrates a system diagram of various components of vehicle 126 in accordance with an embodiment of the disclosure. As shown, the system may include the cooling system 138 and the computing system 132. The cooling system 138 may include controller 152 in communication (e.g., electrically coupled, such as in wired or wireless communication) with the temperature sensors 146 and the flow sensors 148 to receive temperature and flow rate data measured by the temperature sensors 146 and the flow sensors 148. The controller 152 is also in communication (e.g., electrically coupled, such as in wired or wireless communication) with the pump 150 and/or fan 142 to control and monitor operation of the pump 150 and/or fan 142, such as to adjust operation of the pump 150 and/or fan 142 based on the temperature and flow rate data received from the temperature sensors 146 and the flow sensors 148. In such embodiments, the controller 152 may be configured to adjust coolant output based on detected conditions (e.g., based on the temperature of the processing components 136, the temperature of the cabin air within the compartment 130 and/or vehicle cabin 128, the temperature of the cooling fluid, etc.). For example, the controller 152 may be configured to determine whether the observed temperature of the cooling fluid or cabin air meets or exceeds a threshold temperature value, and if so, adjust operation of the pump 150 to increase the flow rate of the cooling fluid through the flow channels. In some embodiments, the controller 152 may be configured to adjust operation of the fan 142 to increase the airflow across the heat exchanger 140 if the observed temperature meets or exceeds the threshold temperature value. As shown, the cooling system 138 includes heat exchanger 140, and the computing system 132 includes one or more processing components 136a and/or one or more processing components 136b, as explained above.

With continued reference to FIG. 7, the system may include an air conditioning system 196 of vehicle 126. In such embodiments, operation of the cooling system 138 may be tied to or associated with the air conditioning system 196. For example, because one or more processing components 136 may be at least partially air cooled via ambient cabin or compartment air, the cooling system 138 may utilize the cabin air pushed by the air conditioning system 196 to supplement cooling of the processing components 136. The fan 142 may also be configured to move the cabin air conditioned by the air conditioning system 196 across the heat exchanger 140 to increase cooling of the processing components 136.

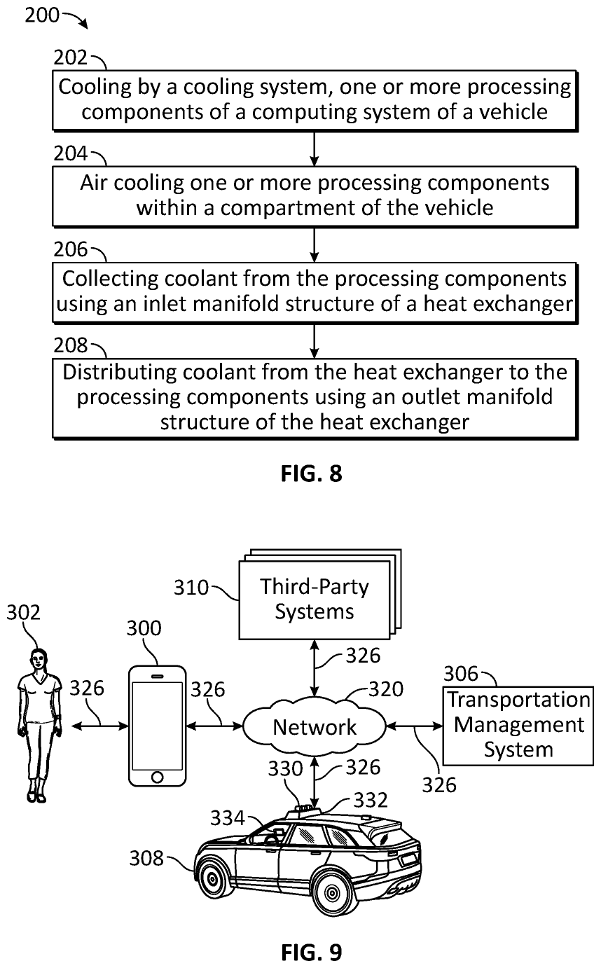

FIG. 8 illustrates a flow diagram of a process 200 of cooling one or more components of a computing system in accordance with an embodiment of the disclosure. It should be appreciated that any step, sub-step, sub-process, or block of process 200 may be performed in an order or arrangement different from the embodiments illustrated by FIG. 8. For example, one or more blocks may be omitted from or added to the process 200. Although process 200 is described with reference to the embodiments of FIGS. 1-5, process 200 may be applied to other embodiments.

In Block 202, process 200 includes cooling, by a cooling system, a plurality of liquid-cooled processing components of a computing system of a vehicle. The liquid-cooled processing components may be located within a compartment of the vehicle. The cooling system may be similar to the cooling system 138 described above. For instance, the cooling system may include a heat exchanger defining a plurality of flow channels and a fan configured to move air within the compartment across the heat exchanger to cool the liquid-cooled processing components. Each flow channel may be associated with a subset of liquid-cooled processing components, such as a single processing component or multiple processing components.

In Block 204, process 200 may include cooling one or more air-cooled processing components within the compartment of the vehicle. Cooling the air-cooled processing components may heat surrounding air within the compartment of the vehicle. For example, heat from the air-cooled processing components may be dissipated to the surrounding air through convective heat transfer. In such embodiments, the fan may be configured to move the heated surrounding air across the heat exchanger to cool the liquid-cooled processing components.

In Block 206, process 200 may include collecting coolant from the liquid-cooled processing components using an inlet manifold structure of the heat exchanger. The inlet manifold structure may include a plurality of inlets. Each inlet may be interchangeable with a different inlet to vary a flow characteristic of an associated flow channel of the heat exchanger. For example, each inlet may be replaced with a different inlet having a different internal diameter. Replacing an existing inlet with an inlet having a larger internal diameter may decrease the flow rate through the associated flow channel of the heat exchanger. Similarly, replacing an existing inlet with an inlet having a smaller internal diameter may increase the flow rate through the associated flow channel of the heat exchanger.

In Block 208, process 200 may include dispersing coolant from the heat exchanger to the liquid-cooled processing components using an outlet manifold structure of the heat exchanger. The outlet manifold structure may include a plurality of outlets. Each outlet may be interchangeable with a different outlet to vary a flow characteristic of an associated flow channel of the heat exchanger. For example, each outlet may be replaced with a different outlet having a different internal diameter. Replacing an existing outlet with an outlet having a larger internal diameter may decrease the flow rate through the associated flow channel of the heat exchanger. Similarly, replacing an existing outlet with an outlet having a smaller internal diameter may increase the flow rate through the associated flow channel of the heat exchanger.

The process 200 illustrated in FIG. 8 is illustrative only, and the process 200 may include additional blocks, steps, or processes. As one non-limiting example, process 200 may include adjusting one or more processing components of the computing system. For instance, one or more liquid-cooled processing components of the computing system may be replaced, updated, or removed. In some embodiments, one or more liquid-cooled processing components may be added to the computing system. The updated or adjusted computing system may have different cooling requirements, such as the new processing components having increased or decreased cooling requirements. In such embodiments, the inlets and/or outlets may be changed to adjust the flow rates as appropriate.

FIG. 9 illustrates a diagram of a transportation management environment for matching ride requestors with vehicles, such as one or more vehicles including the cooling system described above. The transportation management environment may include various computing entities or devices, such as a user computing device 300 of a user 302 (e.g., a ride provider or requestor), a transportation management system 306, a vehicle 308, and one or more third-party systems 310. The vehicle 308 can be autonomous, semi-autonomous, or manually drivable. The computing entities may be communicatively connected over a network 320. As an example and not by way of limitation, one or more portions of network 320 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. Any suitable network arrangement and protocol enabling the computing entities to communicate with each other may be used. Although FIG. 9 illustrates a single user device 300, a single transportation management system 306, a single vehicle 308, a plurality of third-party systems 310, and a single network 320, any suitable number of each of these entities may be utilized. As an example, and not by way of limitation, the transportation management environment may include multiple users 302, user devices 300, transportation management systems 306, vehicles 308, third-party systems 310, and networks 320. In some embodiments, some or all of the blocks or modules shown in FIG. 8 may be implemented by one or more computing systems of the transportation management system 306. In some embodiments, some or all of the blocks or modules shown in FIG. 8 may be implemented by one or more computing systems in the vehicle 308.

The user device 300, transportation management system 306, vehicle 308, and third-party system 310 may be communicatively connected or co-located with each other in whole or in part. These computing entities may communicate via different transmission technologies and network types. For example, the user device 300 and the vehicle 308 may communicate with each other via a cable or short-range wireless communication (e.g., Bluetooth, NFC, WI-FI, etc.), and together they may be connected to the Internet via a cellular network that is accessible to either one of the devices (e.g., the user device 300 may be a smartphone with LTE connection). The transportation management system 306 and third-party system 310, on the other hand, may be connected to the Internet via their respective LAN/WLAN networks and Internet Service Providers (ISP).

FIG. 9 illustrates transmission links 326 that connect user device 300, vehicle 308, transportation management system 306, and third-party system 310 to communication network 320. Any suitable transmission link 326 is contemplated, including, for example, wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof. One or more transmission links 326 may connect to one or more networks 320, which may include in part, for example, an ad-hoc network, the Intranet, extranet, VPN, LAN, WLAN, WAN, WWAN, MAN, PSTN, a cellular network, a satellite network, or any combination thereof. The computing entities need not necessarily use the same type of transmission link 326. For example, the user device 300 may communicate with the transportation management system 306 via a cellular network and the Internet, but communicate with the vehicle 308 via Bluetooth or a physical wire connection.

The transportation management system 306 may fulfill ride requests for one or more users 302 by dispatching suitable vehicles. The transportation management system 306 may receive any number of ride requests from any number of ride requestors 302. A ride request from a ride requestor 302 may include an identifier that identifies the ride requestor 302 in the system 306. The transportation management system 306 may use the identifier to access and store information about the ride requestor 302 (i.e., ride requestor information), in accordance with the requestor's privacy settings. The ride requestor information may be stored in one or more data stores (e.g., a relational database system) associated with and accessible to the transportation management system 306. The ride requestor information may include profile information about the ride requestor 302. In some embodiments, the ride requestor 302 may be associated with one or more categories or types, through which the ride requestor 302 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when travelling at various speeds, route, etc.), entertainment preferences and settings (e.g., preferred music genre or playlist, audio volume, display brightness, etc.), temperature settings, whether conversation with the driver is welcomed, frequent destinations, historical riding patterns (e.g., time of day of travel, starting and ending locations, etc.), preferred language, age, gender, or any other suitable information. The transportation management system 306 may classify a ride requestor 302 based on known information about the ride requestor 302 (e.g., using machine-learning classifiers), and use the classification to retrieve relevant aggregate information associated with that class. For example, the transportation management system 306 may classify a ride requestor 302 as a young adult and retrieve relevant aggregate information associated with young adults, such as the type of music generally preferred by young adults.

Transportation management system 306 may also store and access ride information. Ride information may include locations related to the ride, traffic data, route options, optimal pick-up or drop-off locations for the ride, or any other suitable information associated with a ride. As an example, and not by way of limitation, when the transportation management system 306 receives a request to travel from San Francisco International Airport (SFO) to Palo Alto, Calif., the transportation management system 306 may access or generate any relevant ride information for this particular ride request. The ride information may include, for example, preferred pick-up locations at SFO; alternate pick-up locations in the event that a pick-up location is incompatible with the ride requestor 302 (e.g., the ride requestor 302 may be disabled and cannot access the pick-up location) or the pick-up location is otherwise unavailable due to construction, traffic congestion, changes in pick-up/drop-off rules, or any other reason; one or more routes to navigate from SFO to Palo Alto; preferred off-ramps for a type of user; or any other suitable information associated with the ride.

In some embodiments, portions of the ride information may be based on historical data associated with historical rides facilitated by the transportation management system 306. For example, historical data may include aggregate information generated based on past ride information, which may include any ride information described herein and telemetry data collected by sensors in vehicles and user devices. Historical data may be associated with a particular ride requestor 302 (e.g., preferences, common routes, etc. of the ride requestor 302), a category/class of users (e.g., based on demographics), and all users of the transportation management system 306. For example, historical data specific to a single ride requestor 302 may include information about past rides that the ride requestor 302 has taken, including the locations at which the ride requestor 302 is picked up and dropped off, music the ride requestor 302 likes to listen to, traffic information associated with the rides, time of the day the ride requestor 302 most often rides, and any other suitable information specific to the ride requestor 302. As another example, historical data associated with a category/class of ride requestors may include, e.g., common or popular ride preferences of ride requestors in that category/class, such as teenagers preferring pop music, ride requestors who frequently commute to the financial district may prefer to listen to the news, etc. As yet another example, historical data associated with all ride requestors may include general usage trends, such as traffic and ride patterns. Using historical data, the transportation management system 306 may predict and provide ride suggestions in response to a ride request.

In some embodiments, the transportation management system 306 may use machine-learning, such as neural networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable machine-learning algorithms known to persons of ordinary skill in the art. The machine-learning models may be trained using any suitable training algorithm, including supervised learning based on labeled training data, unsupervised learning based on unlabeled training data, and semi-supervised learning based on a mixture of labeled and unlabeled training data.

The transportation management system 306 may include one or more server computers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. Each server may include hardware, software, or embedded logic components or a combination of two or more such components for carrying out the appropriate functionalities implemented or supported by the server. In some embodiments, the transportation management system 306 may include one or more data stores. The data stores may be used to store various types of information, such as ride information, ride requestor information, ride provider information, historical information, third-party information, or any other suitable type of information. The information stored in the data stores may be organized according to specific data structures. Each data store may be a relational, columnar, correlation, or any other suitable type of database system. Although this disclosure describes or illustrates particular types of databases, this disclosure contemplates any suitable types of databases. Particular embodiments may provide interfaces that enable a user device 300 (which may belong to a ride requestor or provider), a transportation management system 306, vehicle system 308, or a third-party system 310 to process, transform, manage, retrieve, modify, add, or delete the information stored in the data store.

In some embodiments, the transportation management system 306 may include an authorization server (or any other suitable component(s)) that allows ride requestors 302 to opt-in to or opt-out of having their information and actions logged, recorded, or sensed by the transportation management system 306 or shared with other systems (e.g., third-party systems 310). In some embodiments, a ride requestor 302 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the ride requestors 302 of transportation management system 306 through blocking, data hashing, anonymization, or other suitable techniques as appropriate.

The third-party system 310 may be a network-addressable computing system that may provide HD maps or host GPS maps, customer reviews, music or content, weather information, or any other suitable type of information. Third-party system 310 may generate, store, receive, and send relevant data, such as, for example, map data, customer review data from a customer review website, weather data, or any other suitable type of data. Third-party system 310 may be accessed by the other computing entities of the network environment either directly or via network 320. For example, user device 300 may access the third-party system 310 via network 320, or via transportation management system 306. In the latter case, if credentials are required to access the third-party system 310, the ride requestor 302 may provide such information to the transportation management system 306, which may serve as a proxy for accessing content from the third-party system 310.

The user device 300 may be a mobile computing device such as a smartphone, tablet computer, or laptop computer. User device 300 may include one or more processors (e.g., CPU, GPU), memory, and storage. An operating system and applications may be installed on the user device 300, such as, e.g., a transportation application associated with the transportation management system 306, applications associated with third-party systems 310, and applications associated with the operating system. User device 300 may include functionality for determining its location, direction, or orientation, based on integrated sensors such as GPS, compass, gyroscope, or accelerometer. User device 300 may also include wireless transceivers for wireless communication and may support wireless communication protocols such as Bluetooth, near-field communication (NFC), infrared (IR) communication, WI-FI, and 2G/3G/4G/LTE/5G mobile communication standard. User device 300 may also include one or more cameras, scanners, touchscreens, microphones, speakers, and any other suitable input-output devices.

The vehicle 308 may be equipped with an array of sensors 330, a navigation system 332, and a ride-service computing device 334. In some embodiments, a fleet of vehicles 308 may be managed by the transportation management system 306. The fleet of vehicles 308, in whole or in part, may be owned by the entity associated with the transportation management system 306, or they may be owned by a third-party entity relative to the transportation management system 306. In either case, the transportation management system 306 may control the operations of the vehicles 308, including, e.g., dispatching select vehicles 308 to fulfill ride requests, instructing the vehicles 308 to perform select operations (e.g., head to a service center or charging/fueling station, pull over, stop immediately, self-diagnose, lock/unlock compartments, change music station, change temperature, and any other suitable operations), and instructing the vehicles 308 to enter select operation modes (e.g., operate normally, drive at a reduced speed, drive under the command of human operators, and any other suitable operational modes).

The vehicles 308 may receive data from and transmit data to the transportation management system 306 and the third-party system 310. Examples of received data may include, e.g., instructions, new software or software updates, maps, 3D models, trained or untrained machine-learning models, location information (e.g., location of the ride requestor, the vehicle 308 itself, other vehicles 308, and target destinations such as service centers), navigation information, traffic information, weather information, entertainment content (e.g., music, video, and news) ride requestor information, ride information, and any other suitable information. Examples of data transmitted from the vehicle 308 may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the vehicle 308, passengers may send/receive data to the transportation management system 306 and third-party system 310), and any other suitable data.

The vehicles 308 may also communicate with each other, including those managed and not managed by the transportation management system 306. For example, one vehicle 308 may communicate with another vehicle data regarding their respective location, condition, status, sensor reading, and any other suitable information. In particular embodiments, vehicle-to-vehicle communication may take place over direct short-range wireless connection (e.g., WI-FI, Bluetooth, NFC) or over a network (e.g., the Internet or via the transportation management system 306 or third-party system 310), or both.

In some embodiments, a vehicle 308 may obtain and process sensor/telemetry data. Such data may be captured by any suitable sensors. For example, the vehicle 308 may have a Light Detection and Ranging (LiDAR) sensor array of multiple LiDAR transceivers that are configured to rotate 360°, emitting pulsed laser light and measuring the reflected light from objects surrounding vehicle 308. In particular embodiments, LiDAR transmitting signals may be steered by use of a gated light valve, which may be a MEMs device that directs a light beam using the principle of light diffraction. Such a device may not use a gimbaled mirror to steer light beams in 360° around the vehicle. Rather, the gated light valve may direct the light beam into one of several optical fibers, which may be arranged such that the light beam may be directed to many discrete positions around the vehicle. Thus, data may be captured in 360° around the vehicle, but no rotating parts may be necessary. A LiDAR is an effective sensor for measuring distances to targets, and as such may be used to generate a three-dimensional (3D) model of the external environment of the vehicle 308. As an example, and not by way of limitation, the 3D model may represent the external environment including objects such as other cars, curbs, debris, objects, and pedestrians up to a maximum range of the sensor arrangement (e.g., 50, 100, or 200 meters). As another example, the vehicle 308 may have optical cameras pointing in different directions. The cameras may be used for, e.g., recognizing roads, lane markings, street signs, traffic lights, police, other vehicles, and any other visible objects of interest. To enable the vehicle 308 to “see” at night, infrared cameras may be installed. In particular embodiments, the vehicle may be equipped with stereo vision for, e.g., spotting hazards such as pedestrians or tree branches on the road. As another example, the vehicle 308 may have radars for, e.g., detecting other vehicles and hazards afar. Furthermore, the vehicle 308 may have ultrasound equipment for, e.g., parking and obstacle detection. In addition to sensors enabling the vehicle 308 to detect, measure, and understand the external world around it, the vehicle 308 may further be equipped with sensors for detecting and self-diagnosing the vehicle's own state and condition. For example, the vehicle 308 may have wheel sensors for, e.g., measuring velocity; global positioning system (GPS) for, e.g., determining the vehicle's current geolocation; and inertial measurement units, accelerometers, gyroscopes, and odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieved using any combination of sensors. For example, the vehicle 308 may build a 3D model of its surrounding based on data from its LiDAR, radar, sonar, and cameras, along with a pre-generated map obtained from the transportation management system 306 or the third-party system 310. Although sensors 330 appear in a particular location on the vehicle 308 in FIG. 9, sensors 330 may be located in any suitable location in or on the vehicle 308. Example locations for sensors include the front and rear bumpers, the doors, the front windshield, on the side panel, or any other suitable location.

In some embodiments, the vehicle 308 may be equipped with a processing unit (e.g., one or more CPUs and GPUs), memory, and storage. The vehicle 308 may thus be equipped to perform a variety of computational and processing tasks, including processing the sensor data, extracting useful information, and operating accordingly. For example, based on images captured by its cameras and a machine-vision model, the vehicle 308 may identify particular types of objects captured by the images, such as pedestrians, other vehicles, lanes, curbs, and any other objects of interest.

In particular embodiments, the vehicle 308 may have a navigation system 332 responsible for safely navigating the vehicle 308. The navigation system 332 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 332 may also utilize, e.g., map data, traffic data, accident reports, weather reports, instructions, target destinations, and any other suitable information to determine navigation routes and particular driving operations (e.g., slowing down, speeding up, stopping, swerving, etc.). The navigation system 332 may use its determinations to control the vehicle 308 to operate in prescribed manners and to guide the vehicle 308 to its destinations without colliding into other objects. Although the physical embodiment of the navigation system 332 (e.g., the processing unit) appears in a particular location on the vehicle 308 in FIG. 9, navigation system 332 may be located in any suitable location in or on the vehicle 308. Example locations for navigation system 332 include inside the cabin or passenger compartment of the vehicle 308, near the engine/battery, near the front seats, rear seats, or in any other suitable location.

In particular embodiments, the vehicle 308 may be equipped with a ride-service computing device 334, which may be a tablet or any other suitable device installed by transportation management system 306 to allow the user to interact with the vehicle 308, transportation management system 306, other users 302, or third-party systems 310. In particular embodiments, installation of ride-service computing device 334 may be accomplished by placing the ride-service computing device 334 inside the vehicle 308, and configuring it to communicate with the vehicle 308 via a wired or wireless connection (e.g., via Bluetooth). Although FIG. 9 illustrates a single ride-service computing device 334 at a particular location in the vehicle 308, the vehicle 308 may include several ride-service computing devices 334 in several different locations within the vehicle. As an example, and not by way of limitation, the vehicle 308 may include four ride-service computing devices 334 located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device 334 may be detachable from any component of the vehicle 308. This may allow users to handle ride-service computing device 334 in a manner consistent with other tablet computing devices. As an example, and not by way of limitation, a user may move ride-service computing device 334 to any location in the cabin or passenger compartment of the vehicle 308, may hold ride-service computing device 334, or handle ride-service computing device 334 in any other suitable manner. Although this disclosure describes providing a particular computing device in a particular manner, this disclosure contemplates providing any suitable computing device in any suitable manner.

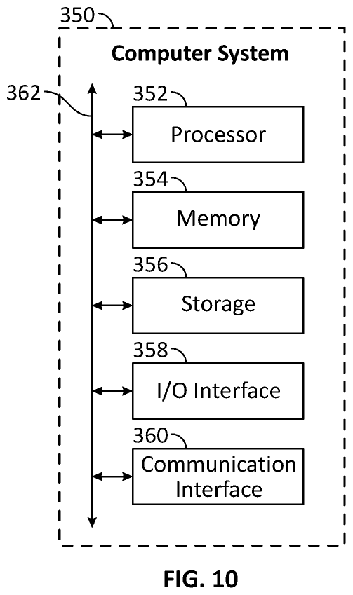

FIG. 10 illustrates a diagram of a computer system 350 in accordance with an embodiment of the disclosure. The computer system 350 may be similar to the computing system 132 of FIG. 2. In particular embodiments, one or more computer systems 350 perform one or more steps of one or more methods described above or illustrated in at least FIG. 8. In particular embodiments, one or more computer systems 350 provide the functionalities described or illustrated herein. In particular embodiments, software running on one or more computer systems 350 performs one or more steps of one or more methods described or illustrated herein or provides the functionalities described or illustrated herein. Particular embodiments include one or more portions of one or more computer systems 350. Herein, a reference to a computer system may encompass a computing device, and vice versa, where appropriate. Moreover, a reference to a computer system may encompass one or more computer systems, where appropriate.

This disclosure contemplates any suitable number of computer systems 350. This disclosure contemplates computer system 350 taking any suitable physical form. As example and not by way of limitation, computer system 350 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 350 may include one or more computer systems 350; be unitary or distributed; span multiple locations; span multiple machines; span multiple data centers; or reside in a cloud, which may include one or more cloud components in one or more networks. Where appropriate, one or more computer systems 350 may perform without substantial spatial or temporal limitation one or more steps of one or more methods described or illustrated herein. As an example, and not by way of limitation, one or more computer systems 350 may perform in real time or in batch mode one or more steps of one or more methods described or illustrated herein. One or more computer systems 350 may perform at different times or at different locations one or more steps of one or more methods described or illustrated herein, where appropriate.

In particular embodiments, computer system 350 includes a processor 352, memory 354, storage 356, an input/output (I/O) interface 358, a communication interface 360, and a bus 362. Although this disclosure describes and illustrates a particular computer system having a particular number of particular components in a particular arrangement, this disclosure contemplates any suitable computer system having any suitable number of any suitable components in any suitable arrangement.

In particular embodiments, processor 352 includes hardware for executing instructions, such as those making up a computer program. As an example, and not by way of limitation, to execute instructions, processor 352 may retrieve (or fetch) the instructions from an internal register, an internal cache, memory 354, or storage 356; decode and execute them; and then write one or more results to an internal register, an internal cache, memory 354, or storage 356. In particular embodiments, processor 352 may include one or more internal caches for data, instructions, or addresses. This disclosure contemplates processor 352 including any suitable number of any suitable internal caches, where appropriate. As an example, and not by way of limitation, processor 352 may include one or more instruction caches, one or more data caches, and one or more translation lookaside buffers (TLBs). Instructions in the instruction caches may be copies of instructions in memory 354 or storage 356, and the instruction caches may speed up retrieval of those instructions by processor 352. Data in the data caches may be copies of data in memory 354 or storage 356 that are to be operated on by computer instructions; the results of previous instructions executed by processor 352 that are accessible to subsequent instructions or for writing to memory 354 or storage 356; or any other suitable data. The data caches may speed up read or write operations by processor 352. The TLBs may speed up virtual-address translation for processor 352. In particular embodiments, processor 352 may include one or more internal registers for data, instructions, or addresses. This disclosure contemplates processor 352 including any suitable number of any suitable internal registers, where appropriate. Where appropriate, processor 352 may include one or more arithmetic logic units (ALUs), be a multi-core processor, or include one or more processors 352. Although this disclosure describes and illustrates a particular processor, this disclosure contemplates any suitable processor.

In particular embodiments, memory 354 includes main memory for storing instructions for processor 352 to execute or data for processor 352 to operate on. As an example and not by way of limitation, computer system 350 may load instructions from storage 356 or another source (such as another computer system 350) to memory 354. Processor 352 may then load the instructions from memory 354 to an internal register or internal cache. To execute the instructions, processor 352 may retrieve the instructions from the internal register or internal cache and decode them. During or after execution of the instructions, processor 352 may write one or more results (which may be intermediate or final results) to the internal register or internal cache. Processor 352 may then write one or more of those results to memory 354. In particular embodiments, processor 352 executes only instructions in one or more internal registers or internal caches or in memory 354 (as opposed to storage 356 or elsewhere) and operates only on data in one or more internal registers or internal caches or in memory 354 (as opposed to storage 356 or elsewhere). One or more memory buses (which may each include an address bus and a data bus) may couple processor 352 to memory 354. Bus 362 may include one or more memory buses, as described in further detail below. In particular embodiments, one or more memory management units (MMUs) reside between processor 352 and memory 354 and facilitate accesses to memory 354 requested by processor 352. In particular embodiments, memory 354 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. Any suitable RAM is contemplated. Memory 354 may include one or more memories 354, where appropriate. Although this disclosure describes and illustrates particular memory, this disclosure contemplates any suitable memory.

In particular embodiments, storage 356 includes mass storage for data or instructions. As an example, and not by way of limitation, storage 356 may include a hard disk drive (HDD), a floppy disk drive, flash memory, an optical disc, a magneto-optical disc, magnetic tape, or a Universal Serial Bus (USB) drive or a combination of two or more of these. Storage 356 may include removable or non-removable (or fixed) media, where appropriate. Storage 356 may be internal or external to computer system 350, where appropriate. In particular embodiments, storage 356 is non-volatile, solid-state memory. In particular embodiments, storage 356 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 356 taking any suitable physical form. Storage 356 may include one or more storage control units facilitating communication between processor 352 and storage 356, where appropriate. Where appropriate, storage 356 may include one or more storages 356. Although this disclosure describes and illustrates particular storage, this disclosure contemplates any suitable storage.

In particular embodiments, I/O interface 358 includes hardware or software, or both, providing one or more interfaces for communication between computer system 350 and one or more I/O devices. Computer system 350 may include one or more of these I/O devices, where appropriate. One or more of these I/O devices may enable communication between a person and computer system 350. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 358 for them. Where appropriate, I/O interface 358 may include one or more device or software drivers enabling processor 352 to drive one or more of these I/O devices. I/O interface 358 may include one or more I/O interfaces 358, where appropriate. Although this disclosure describes and illustrates a particular I/O interface, this disclosure contemplates any suitable I/O interface.

In particular embodiments, communication interface 360 includes hardware or software, or both providing one or more interfaces for communication (such as, for example, packet-based communication) between computer system 350 and one or more other computer systems 350 or one or more networks. As an example, and not by way of limitation, communication interface 360 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 360 for it. As an example, and not by way of limitation, computer system 350 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 350 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 350 may include any suitable communication interface 360 for any of these networks, where appropriate. Communication interface 360 may include one or more communication interfaces 360, where appropriate. Although this disclosure describes and illustrates a particular communication interface, this disclosure contemplates any suitable communication interface.

In particular embodiments, bus 362 includes hardware or software, or both coupling components of computer system 350 to each other. As an example and not by way of limitation, bus 362 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 362 may include one or more buses 362, where appropriate. Although this disclosure describes and illustrates a particular bus, this disclosure contemplates any suitable bus or interconnect.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise.

Herein, a computer-readable non-transitory storage medium or media may include one or more semiconductor-based or other types of integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Methods described herein may vary in accordance with the present disclosure. Various embodiments of this disclosure may repeat one or more steps of the methods described herein, where appropriate. Although this disclosure describes and illustrates particular steps of certain methods as occurring in a particular order, this disclosure contemplates any suitable steps of the methods occurring in any suitable order or in any combination which may include all, some, or none of the steps of the methods. Where applicable, the ordering of various steps described herein can be changed, combined into composite steps, and/or separated into sub-steps to provide features described herein. Furthermore, although this disclosure may describe and illustrate particular components, devices, or systems carrying out particular steps of a method, this disclosure contemplates any suitable combination of any suitable components, devices, or systems carrying out any suitable steps of the method.

Herein, “or” is inclusive and not exclusive, unless expressly indicated otherwise or indicated otherwise by context. Therefore, herein, “A or B” means “A or B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, modules, elements, feature, functions, operations, or steps, any of these embodiments may include any combination or permutation of any of the components, modules, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages. Thus, embodiments described above illustrate but do not limit the invention.

What is claimed is:

1. A vehicle having a compartment, the vehicle comprising:
a computing system comprising one or more processing components located within the compartment; and
a cooling system configured to cool the one or more processing components, the cooling system comprising:
a heat exchanger defining a plurality of flow channels, wherein each flow channel of the plurality of flow channels is defined by an outlet and configured to provide fluid; and
one or more tubes positioned between the heat exchanger and the one or more processing components, wherein the tubes are configured to provide the fluid from the outlets of the heat exchanger to cool the one or more processing components.

2. The vehicle of claim 1, wherein:
operation of the one or more processing components heats surrounding air within the compartment of the vehicle; and
the cooling system comprises a fan configured to move the heated surrounding air across the heat exchanger to cool the fluid included within the flow channels.

3. The vehicle of claim 3, further comprising:
a cabin, wherein the compartment is exposed to the cabin, and the compartment is capable of receiving cabin air from within the cabin and directing the cabin air therethrough to cool the one or more processing components.

4. The vehicle of claim 3, wherein the heat exchanger is capable of receiving the cabin air from within the cabin and directing the cabin air therethrough to cool the fluid within the flow channels.

5. The vehicle of claim 1, wherein at least two of the outlets of the heat exchanger have different internal diameters so that a first outlet of the at least two outlets is characterized as having a first fluid flow rate and a second outlet of the at least two outlets is characterized as having a second fluid flow rate less than the first fluid flow rate.

6. The vehicle of claim 5, wherein at least two of the plurality of flow channels share an inlet, and the heat exchanger is configured to produce a variable distributed flow across the flow channels, the variable distributed flow resulting from the first outlet having a different internal diameter than the second outlet.

7. The vehicle of claim 1, further comprising:
one or more sensors configured to determine a temperature of at least one of the fluid or the air within the compartment; and
a controller in communication with the one or more sensors and configured to adjust a flow rate of the fluid through the plurality of flow channels based on the temperature.

8. The vehicle of claim 7, further comprising a pump, wherein the controller is configured to:
determine whether the temperature meets or exceeds a threshold temperature value; and
adjust operation of the pump to increase the flow rate of the fluid through the plurality of flow channels if the temperature meets or exceeds the threshold temperature value.

9. The vehicle of claim 1, wherein:
the compartment is a trunk of the vehicle;
the vehicle is an autonomous vehicle; and
the heat exchanger is located within the compartment and near the one or more processing components, the heat exchanger receiving therethrough cabin air within the compartment to cool the fluid.

10. A cooling system configured to cool one or more processing components of a vehicle, the cooling system comprising:
a heat exchanger comprising:
a core;
at least one inlet supported by the core and configured to receive cooling fluid;
a plurality of outlets supported by the core and configured to receive the cooling fluid from the at least one inlet; and
a plurality of flow channels defined by the at least one inlet and the plurality of outlets, the plurality of flow channels extending through the core and configured to direct the cooling fluid to the one or more processing components.

11. The cooling system of claim 10, wherein:
operation of the one or more processing components heats surrounding air within the compartment of the vehicle; and
the cooling system comprises a fan configured to move the heated surrounding air across the heat exchanger to cool the cooling fluid.

12. The cooling system of claim 10, wherein at least two of the plurality of outlets have different internal diameters.

13. The cooling system of claim 10, wherein:
the at least one inlet comprises a plurality of inlets supported by an inlet manifold structure of the heat exchanger; and
the plurality of outlets is supported by an outlet manifold structure of the heat exchanger.

14. The cooling system of claim 10, further comprising:
one or more sensors configured to determine a temperature of the cooling fluid; and
a controller configured to adjust a flow rate of the cooling fluid based on the temperature.

15. A vehicle having a compartment exposed to cabin air within the vehicle, the vehicle comprising:
a computing system comprising one or more processing components located within the compartment; and
a cooling system located within the compartment and configured to cool the one or more processing components, the cooling system comprising a heat exchanger exposed to the cabin air within the vehicle so as to cool cooling fluid sent to the one or more processing components, the heat exchanger comprising:
a core;
at least one inlet supported by the core and configured to receive the cooling fluid;
a plurality of outlets supported by the core and configured to receive the cooling fluid from the at least one inlet; and
a plurality of flow channels defined by the at least one inlet and the plurality of outlets, the plurality of flow channels extending through the core and configured to direct the cooling fluid to the one or more processing components.

16. The vehicle of claim 15, wherein the one or more processing components are cooled by a combination of the cabin air within the vehicle and the cooling fluid.

17. The vehicle of claim 15, wherein:
the one or more processing components comprises a first processing component having a first operating temperature and a second processing component having a second operating temperature different than the first operating temperature; and
the first processing component and the second processing component are cooled by different flow channels of the plurality of flow channels, the different flow channels operating at different flow rates of cooling fluid.

18. The vehicle of claim 15, wherein at least two outlets of the plurality of outlets have different internal diameters.

19. The vehicle of claim 15, wherein the at least one inlet comprises a plurality of inlets supported by the core.

20. The vehicle of claim 15, further comprising:
one or more sensors configured to determine a temperature of the cooling fluid or the cabin air within the compartment; and
a controller configured to adjust a flow rate of the cooling fluid based on the temperature.
